(19) United States
(12) Patent Application Publication
(10) Pub. No.: US 2026/0341207 A1
(43) Pub. Date: Oct. 29, 2026

(54) DISPLAY DEVICE AND DRIVING METHOD THEREFOR

(71) Applicant: CHIPONE TECHNOLOGY (ZHUHAI) CO., LTD., Zhuhai (CN)

(72) Inventor: Pinyan GUO, Zhuhai (CN)

(73) Assignee: Chipone Technology (Beijing) Co., Ltd., Zhuhai, CN (CN)

(21) Appl. No.: 19/124,277

(22) PCT Filed: Aug. 8, 2023
(86) PCT No.: PCT/CN2023/111611

§ 371 Date: Apr. 24, 2025

(30) Foreign Application Priority Data
Oct. 24, 2022 (CN) 202211302215.X

(51) Int. Cl. G09G 3/3225; G09G 3/32; G09G 3/36

(52) U.S. Cl. CPC G09G 3/3225; G09G 3/32; G09G 3/3648; G09G 2320/0233; G09G 2320/0285; G09G 2320/041; G09G 2320/0626

(57) ABSTRACT

The present disclosure presents a display device and a driving method therefor. The device comprises a pixel array with multiple pixel units, a temperature sensing unit, and compensation lines coupled to pixel units in each row. A brightness compensation circuit generates a compensation signal in accordance with temperature information to adjust the light-emitting duration of pixel units. The driving method involves sensing the display device's temperature, obtaining a compensation signal using a temperature lookup table, and dynamically adjusting pixel brightness in each frame to balance temperature and brightness.

This application claims priority to Chinese Patent Application No. 202211302215X, filed on Oct. 24, 2022, titled “display device and driving method therefor”, which is incorporated herein by reference in its entirety in this disclosure, including the specification, claims, drawings and abstract.

### FIELD OF TECHNOLOGY

The present disclosure relates to the field of display technology, and more particularly to a display device and a driving method therefor.

### BACKGROUND

In recent years, OLED (Organic Light-Emitting Diode) display devices have gradually become one of the mainstream display devices due to their advantages such as self-emission, thinness, low power consumption, fast response speed, and low manufacturing cost. An OLED display device comprises a substrate, on which organic light-emitting units are formed, which consist of pixel circuits, anodes, organic light-emitting layers, cathodes, and other layers. The anodes and cathodes are led out at non-light-emitting region and are bonded with integrated circuits or FPC (Flexible Printed Circuit).

The light-emitting devices of OLED display devices are sensitive to temperature. They exhibit different brightness-voltage characteristic curves at different temperatures. As shown in FIG. 1, when the voltage is V1, the brightness of the light-emitting device at 50 °C is greater than that at 40 °C, and the brightness at 40 °C is greater than that at 30 °C. When the OLED is in operation and the voltage is constant, the brightness of the light-emitting device increases with temperature, which further increases the temperature, leading to changes in the brightness-voltage characteristic curve, and the brightness increases again, which forms a vicious cycle of positive feedback. Excessive brightness and/or temperature not only affect the display effect of the OLED display device but also accelerate the aging of the light-emitting device, shortening the product's lifespan, which is more evident in micro OLED display devices.

Conventional solutions, as shown in FIG. 2, comprise: step S10, where the display device is in operation, the temperature rise due to the aforementioned reasons; step S20, sensing the temperature of the pixel array to obtain a first temperature; step S30, determining whether the first temperature is greater than a preset temperature, if yes, then proceeding to step S50 to turn off the display device; if no, then returning to step S10. Conventional solutions generally adopt real-time temperature sensing, cutting off power when the temperature exceeds a preset level to force the display device into sleep mode, ensuring it is not damaged by high temperatures. However, this method cannot solve the brightness change caused by temperature and forced sleep can lead to display interruption.

Therefore, an improved display device and driving method are expected to solve the above problems.

### SUMMARY OF THE DISCLOSURE

In view of the above problems, the objective of the present disclosure is to provide a driving method for a display device and the display device itself, which can automatically adjust the light-emitting duration of pixel units when the temperature of the display device changes, thereby reducing the brightness of the display device at high temperatures.

According to one aspect of the present disclosure, a driving method for a display device is provided. The display device comprises a plurality of pixel units arranged in an array. The driving method comprises: sensing the current temperature of the display device to obtain temperature information; obtaining a compensation signal with a selected duty cycle in accordance with the temperature information and a temperature lookup table; and dynamically adjusting the light-emitting duration of the plurality of pixel units in each frame in accordance with the compensation signal.

Optionally, the step of obtaining a compensation signal with a selected duty cycle in accordance with the temperature information and the temperature lookup table comprises: looking up a corresponding compensation signal setting parameter in the temperature lookup table in accordance with the temperature information; and generating the compensation signal with the selected duty cycle in accordance with the compensation signal setting parameter.

Optionally, the method of establishing the temperature lookup table comprises: under constant temperature conditions, measuring the brightness of the display device and the duty cycle of the compensation signal to obtain their relationship at a plurality of temperature nodes; under constant voltage conditions, controlling the brightness of the display device at different temperature nodes and recording corresponding compensation signal setting parameters; performing linear fitting in accordance with the relationship between brightness and compensation signal setting parameters to obtain compensation signal setting parameters at other temperatures.

Optionally, under constant voltage conditions, controlling the brightness of the display device at different temperature nodes and recording corresponding compensation signal setting parameters comprises: at different temperature nodes, making the brightness of the display device the same as the brightness of the display device at a reference temperature, and recording the corresponding compensation signal setting parameters.

Optionally, under constant voltage conditions, controlling the brightness of the display device at different temperature nodes and recording corresponding compensation signal setting parameters comprises: when the temperature node is higher than the reference temperature, making the brightness of the display device lower than the brightness of the display device at the reference temperature, and recording the corresponding compensation signal setting parameters.

Optionally, making the brightness of the display device lower than the brightness of the display device at the reference temperature comprises: the brightness of the display device decreases in a rate that increases as the temperature node rises.

Optionally, when the temperature represented by the temperature information is greater than a preset temperature, the display device is turned off.

According to another aspect of the present disclosure, a display device capable of executing the any one of the above-mentioned driving methods is provided. The display device comprises: a pixel array, having a plurality of pixel units at intersecting points of a plurality of scan lines and a plurality of data lines; a temperature sensing unit configured to sense the temperature of the pixel array to obtain temperature information; a plurality of compensation lines, each compensation line coupled to at least one pixel unit in the same row; and a brightness compensation circuit coupled to the temperature sensing unit and the plurality of compensation lines, generating a compensation signal with a selected duty cycle in accordance with the temperature information to control the light-emitting duration of the pixel units.

Optionally, the pixel unit comprises: a first transistor, with a control terminal coupled to a scan line, and a first terminal coupled to the data line; a third transistor, a second transistor, and a light-emitting device sequentially coupled in series between an operating voltage and ground, a control terminal of the third transistor coupled to a compensation line; a first capacitor, with one end coupled to a control terminal of the second transistor, and the other end coupled to an intermediate node between the second transistor and the third transistor.

Optionally, the display device further comprises: a gate driving circuit coupled to the plurality of scan lines, providing a plurality of gate driving signals to turn on or off the plurality of pixel units coupled to the plurality of scan lines; a source driving circuit coupled to the plurality of data lines, providing gray-scale display voltages to corresponding pixel units when the pixel units are turned on; a timing control circuit coupled to the gate driving circuit, the source driving circuit, and the brightness compensation circuit to provide corresponding timing signals and control signals.

Optionally, the pixel array is selected from that of an LCD display, an LED display, an OLED display, an AMOLED display, a Micro LED display, or a Mini LED display.

The display device and the driving method therefor provided by the present disclosure, when the temperature changes, automatically change the proportion of light-emitting duration of the pixel units by controlling on and off states of the third transistor in the pixel units, maintaining an equivalent brightness of the display device at different temperature nodes consistent with the brightness of the display device at the reference temperature, dynamically balancing temperature and brightness of the display device.

Optionally, as the temperature rises, the proportion of light-emitting duration of the pixel units, i.e., the duty cycle of the compensation signal, is gradually decreased to achieve the effect of maintaining consistent equivalent brightness. On one hand, the brightness no longer increases with the rise of temperature, ensuring the display device has a good display effect and a long service life. On the other hand, as the temperature rises, the proportion of non-light-emitting duration of the pixel units gradually increases, which helps in heat dissipation and further controls the temperature of the display device.

Optionally, the present disclosure can also perform overcompensation when the temperature represented by the temperature information is higher than the reference temperature, sacrificing brightness for better cooling effects. Further, the degree of overcompensation is positively correlated with the temperature of the display device. When the temperature of the display device is low, the degree of overcompensation is small, ensuring heat dissipation while having little impact on the brightness of the display device. When the temperature of the display device is high, increase the degree of overcompensation, sacrificing brightness for better cooling effects, improving the overall stability and reliability of the display device.

### BRIEF DESCRIPTION OF THE DRAWINGS

The above and other objectives, features, and advantages of the present disclosure will become more apparent from the following detailed description of embodiments of the present disclosure with reference to the accompanying drawings, in which:

FIG. 1 illustrates brightness-voltage characteristic curves of a light-emitting device at different temperatures;

FIG. 2 illustrates a driving method for a display device according to the prior art;

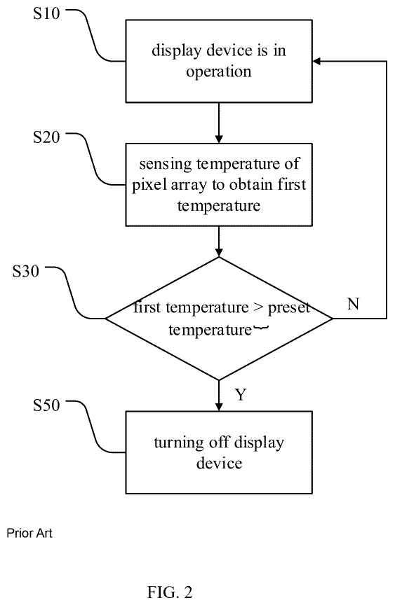

FIG. 3 illustrates a display device according to an embodiment of the present disclosure;

FIG. 4 illustrates a circuit structure diagram of a pixel unit in FIG. 3;

FIG. 5 illustrates a driving method for a display device according to an embodiment of the present disclosure;

FIG. 6 illustrates the duty cycle of compensation signals at different temperature nodes;

FIG. 7 illustrates the relationship between temperature nodes and brightness under constant voltage conditions for the conventional approach and the present disclosure;

FIG. 8 illustrates an establishing approach for the temperature lookup table according to an embodiment of the present disclosure.

### DETAILED DESCRIPTION OF THE DISCLOSURE

Various embodiments of the present disclosure will be described in more detail below with reference to the accompanying drawings. In the drawings, the same elements or modules are denoted by the same or similar reference numerals. For clarity, the parts in the drawings are not drawn to scale.

It should be understood that in the following description, the term “circuit” may comprise a single or multiple combined hardware circuits, programmable circuits, state machine circuits, and/or elements capable of storing instructions executed by programmable circuits. When an element or circuit is “connected to” another element or “connected between” two nodes, it may be directly coupled or connected to another element, or there may be intermediate elements, and the connection between elements may be physical, logical, or a combination thereof. Conversely, when an element is “directly coupled to” or “directly connected to” another element, no intermediate elements are connected between the two elements.

At the same time, certain terms are used in this patent specification and claims to refer to specific components. Those skilled in the art should understand that hardware manufacturers may use different terms to refer to the same component. This patent specification and claims do not distinguish components by name differences but by functional differences.

In the present disclosure, a transistor may comprise one selected from a bipolar transistor or a field-effect transistor, with the first and second ends of the transistor being the high potential terminal and the low potential terminal on the current path, respectively, and the control terminal used to receive a control signal to control on and off states of the transistor. A MOSFET (Metal-Oxide-Semiconductor Field-Effect Transistor) comprises a first terminal, a second terminal, and a control terminal. In a on state of the MOSFET, current flows from the first terminal to the second terminal. The first terminal, second terminal, and control terminal of a P-type MOSFET are the source, drain, and gate, respectively, while those of an N-type MOSFET are the drain, source, and gate, respectively.

Furthermore, it should be noted that in this document, relational terms such as first and second are merely used to distinguish one entity or operation from another entity or operation and do not necessarily require or imply any actual relationship or order between these entities or operations. Moreover, the terms “comprise”, “composed of” or any other variations thereof are intended to cover non-exclusive inclusion, so that a process, method, article, or device that comprises a series of elements not only comprises those elements but also comprises other elements not explicitly listed, or elements inherent to such a process, method, article, or device. Without more constraints, an element defined by the phrase “comprising a . . . ” does not exclude the presence of additional identical elements in the process, method, article, or device that comprises the element.

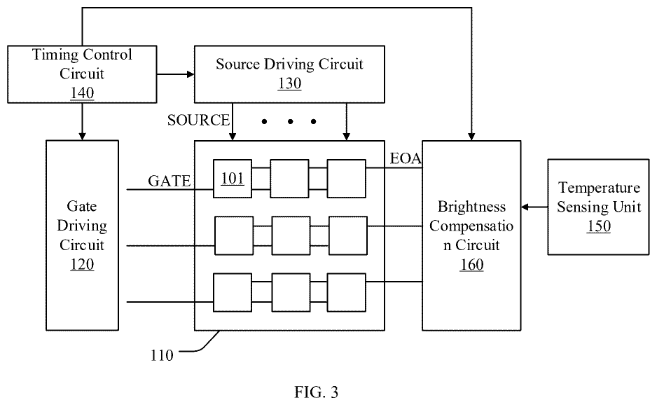

FIG. 3 illustrates a display device according to an embodiment of the present disclosure. The display device comprises a pixel array 110, a gate driving circuit 120, a source driving circuit 130, a timing control circuit 140, a temperature sensing unit 150, and a brightness compensation circuit 160.

The pixel array 110, for example, is formed by a plurality of pixel units 101 arranged in an array at intersections of multiple scan lines and data lines. Generally, the pixel unit 101 mainly comprises transistors, diodes, and capacitors. In this embodiment, the pixel array 110 is selected from any one of a Liquid Crystal Display (LCD), a Light-Emitting Diode (LED) display, an Organic Light-Emitting Diode (OLED) display, an Active-Matrix Organic Light-Emitting Diode (AMOLED) display, a Micro LED display, or a Mini LED display.

The gate driving circuit 120 is coupled to multiple scan lines, providing multiple gate driving signals to turn on or off the multiple pixel units 101 coupled to the corresponding scan lines.

The source driving circuit 130 is coupled to multiple data lines, providing gray-scale display voltages to corresponding pixel units 101 when the pixel units are turned on, thereby providing image signals to the corresponding pixel units 101 to display images.

The timing control circuit 140, for example, receives display data from the front end via a data interface, generates timing signals and control signals in accordance with the display data, and is coupled to the gate driving circuit 120 and the source driving circuit 130, thereby providing corresponding timing signals and control signals to the gate driving circuit 120 and the source driving circuit 130.

The temperature sensing unit 150 senses the temperature of the pixel array 110 and generates corresponding temperature information in accordance with the sensed temperature.

The display device also comprises a plurality of compensation lines, each compensation line coupled to at least one pixel unit 101 in the same row.

The brightness compensation circuit 160 is coupled to the a plurality of compensation lines and the timing control circuit 140, providing multiple compensation signals to corresponding pixel units 101 by changing the duty cycle of the compensation signals to control the conduction time of the pixel units 101. The brightness compensation circuit 160 is also coupled to the temperature sensing unit 150, generating compensation signals with different duty cycles in accordance with the temperature information provided by the temperature sensing unit 150, allowing the pixel units 101 to have different light-emitting durations at different temperatures to control the brightness of the pixel units 101.

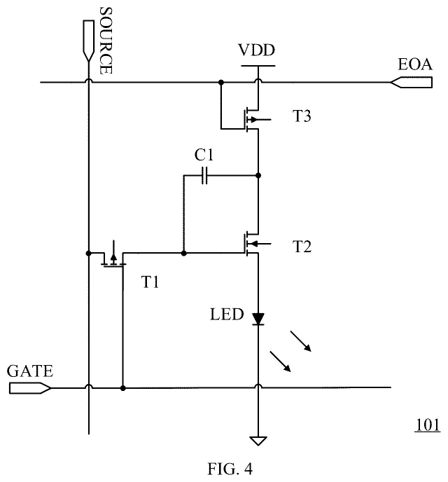

Further, FIG. 4 illustrates a circuit structure diagram of the pixel unit 101 in FIG. 3. The pixel unit 101 comprises a first transistor T1, a second transistor T2, a third transistor T3, a first capacitor C1, and a light-emitting device OLED. The first transistor T1 and the third transistor T3 are selected from P-type field-effect transistors, and the second transistor T2 is selected from N-type field-effect transistors.

The control terminal of the first transistor T1 receives a gate driving signal GATE, and the first terminal receives a gray-scale display voltage SOURCE. The control terminal of the third transistor T3 receives a compensation signal EOA, and the first terminal is coupled to an operating voltage VDD. The control terminal of the second transistor T2 is coupled to the second terminal of the first transistor T1, and the first terminal is coupled to the second terminal of the third transistor T3. The first terminal of the light-emitting device OLED is coupled to the second terminal of the second transistor T2, and the second terminal is grounded. One end of the first capacitor C1 is coupled to the first terminal of the second transistor T2, and the other end is coupled to the control terminal of the second transistor T2.

When the gate driving signal GATE is in a valid state, the first transistor Tl is turned on, and the gray-scale display voltage SOURCE charges the first capacitor C1 through the first transistor T1, while the second transistor T2 is turned on, causing the light-emitting device OLED to display the corresponding brightness.

The third transistor T3 is turned on according to the valid state of the compensation signal EOA, thereby controlling the light-emitting duration of the pixel unit 101. In this embodiment, when the compensation signal EOA is in a low-level state, the third transistor T3 is turned on, and the light-emitting device OLED emits light. When the compensation signal EOA is in a high-level state, the third transistor T3 is turned off, and the light-emitting device OLED does not emit light.

In the present disclosure, the valid state of the gate driving signal GATE controls on and off states of the first transistor T1, and the valid state of the compensation signal EOA controls on and off states of the third transistor T3. That is, the gate driving signal GATE controls whether the pixel unit 101 corresponding to the scan line can receive the gray-scale display voltage, while the compensation signal EOA controls whether the pixel unit 101 corresponding to the compensation line emits light when receiving the gray-scale display voltage SOURCE.

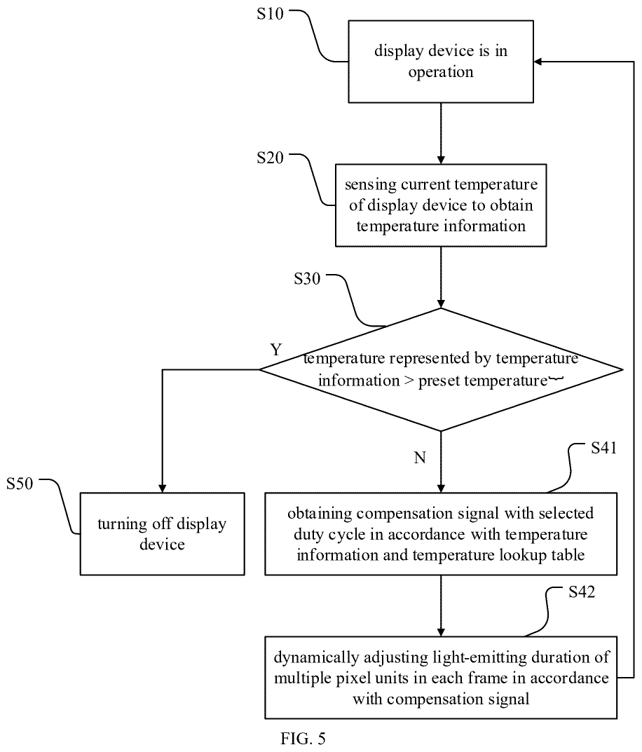

FIG. 5 illustrates a driving method for a display device according to an embodiment of the present disclosure. In conjunction with FIG. 3 and FIG. 4, the driving method is further explained. The driving method of the present disclosure comprises:

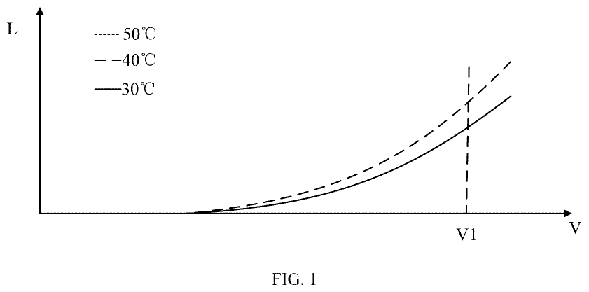

Step S10: The display device is in an operating state. When the display device is in an operating state, the pixel array 110 emits light, causing its temperature to gradually rise. After the temperature rises, due to the change in the characteristic curve shown in FIG. 1, its brightness further increases.

Step S20: the current temperature of the display device is sensed to obtain a temperature signal. The temperature sensing unit 150 senses the temperature of the pixel array 110 in the display device to generate corresponding temperature information and provides the temperature information to the brightness compensation circuit 160.

Step S30: It is determined whether the temperature represented by the temperature information is greater than a preset temperature. If yes, proceed to step S50; if no, proceed to step S41.

Step S41: A compensation signal with a selected duty cycle is obtained in accordance with the temperature information and the temperature lookup table. After retrieving the corresponding compensation signal setting parameter in the temperature lookup table in accordance with the temperature information, a compensation signal with the selected duty cycle is generated.

The brightness compensation circuit 160 receives the temperature information transmitted from the temperature sensing unit 150, retrieves the corresponding compensation signal setting parameter (e.g., the duty cycle of the compensation signal EOA) from the temperature lookup table in accordance with the temperature information, and generates the compensation signal EOA.

Step S42: the light-emitting duration of multiple pixel units in each frame are dynamically adjusted in accordance with the compensation signal.

the compensation signal EOA is generated in step S41, and is provided to the pixel unit 101 to control the light-emitting duration of the pixel unit 101 in the pixel array 110 in each frame. When the temperature is higher than the reference temperature, the light-emitting duration (or the proportion of light-emitting duration) of the pixel unit decreases to lower the brightness of the pixel unit 101, thereby reducing the overall brightness and/or temperature of the pixel array 110.

After step S42, return to step S10, to continue sensing the temperature of the display device to dynamically adjust the temperature/brightness of the display device.

In one embodiment of the present disclosure, to avoid temperature rise while maintaining a good display effect, the duty cycle of the compensation signal EOA should be set to make the brightness of the display device at different temperature nodes the same as the brightness of the display device at the reference temperature.

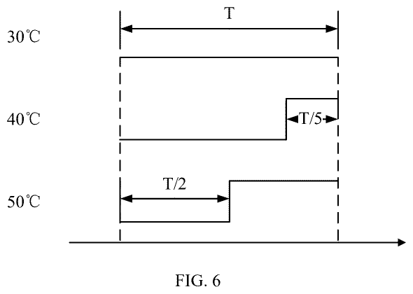

For example, at 30 °C, the duty cycle of the compensation signal EOA for the pixel unit 101 is controlled to be 100%, with a brightness of 300 nits. To maintain the brightness at 300 nits, at 40 °C, the duty cycle of the compensation signal EOA for the pixel unit 101 is controlled to be 80%, and at 50 °C, the duty cycle is controlled to be 50%. The duty cycle of the compensation signal EOA at different temperature nodes is shown in FIG. 6. FIG. 6 illustrates the duty cycle of the compensation signal EOA at different temperature nodes, from top to bottom, at 30 °C, 40 °C, and 50 °C. At 30 °C, the compensation signal EOA is in a low-level state throughout the time period T, and the third transistor T3 is always turned on, and the pixel unit 101 continuously emits light. At 40 °C, the compensation signal EOA is firstly in a low-level state and the third transistor T3 is turned on, and the pixel unit 101 emits light; then, it is in a high-level state to turn off the third transistor T3, causing the pixel unit 101 to stop emitting light. At 50 °C, the compensation signal EOA is firstly in a low-level state, and the third transistor T3 is turned on, and the pixel unit 101 emits light; then, it is in a high-level state to turn off the third transistor T3, causing the pixel unit 101 to stop emitting light.

Under constant voltage conditions, when the display device is in an operating state, the temperature will gradually rise. By generating a compensation signal EOA with the corresponding duty cycle, on and off states of the third transistor T3 in the pixel unit 101 are controlled, thereby controlling the light-emitting duration of the pixel unit 101, making the equivalent brightness of the pixel unit 101 the same as the brightness at the reference temperature, avoiding the increase in brightness caused by the rise in temperature of the display device, and achieving a better display effect. Further, when the compensation signal EOA is in an invalid state, the third transistor T3 is turned off, and the pixel unit 101 stops emitting light, which helps in the heat dissipation of the pixel unit 101. The positive feedback cycle of temperature rise-brightness rise-temperature rise is interrupted, effectively reducing the temperature of the display device when it is in an operating state. Relatively low temperature and/or brightness can not only extend the lifespan of the light-emitting device OLED but also avoid thermal shutdown and its various adverse consequences caused by excessive temperature.

Step S50: The display device is turned off. When the temperature represented by the temperature information is greater than a preset temperature, it will not only cause the aging of the light-emitting device OLED but also easily cause damage to the pixel array 110 and its nearby components. Therefore, it is necessary to turn off the display device to avoid unexpected situations.

The display device and the driving method therefor provided by the present disclosure, when the temperature changes, automatically change the proportion of light-emitting duration of the pixel units by controlling on and off states of the third transistor in the pixel units, maintaining the equivalent brightness of the display device at different temperature nodes consistent with the brightness of the display device at the reference temperature, avoiding long-term high brightness and/or temperature leading to the aging of the light-emitting device OLED.

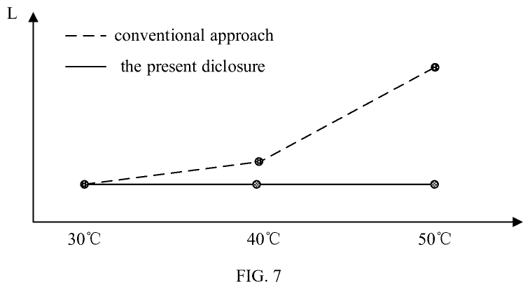

Optionally, as the temperature rises, the proportion of light-emitting duration of the pixel units, i.e., the duty cycle of the compensation signal, is gradually reduced, to achieve the effect of maintaining consistent equivalent brightness, as shown in FIG. 7. FIG. 7 illustrates the relationship between temperature nodes and brightness under constant voltage conditions for the conventional approach and the present disclosure. The dashed line represents the relationship between temperature nodes and brightness in the conventional approach, and the solid line represents the correspondence in the present disclosure. It can be seen that in the conventional approach, the brightness of the display device increases with the rise in temperature, and the higher the temperature, the greater the increase in brightness. In contrast, the brightness of the display device in the present disclosure remains basically constant. On one hand, the brightness no longer increases with the rise in temperature, ensuring the display device has a good display effect and a long service life. On the other hand, as the temperature rises, the proportion of non-light-emitting duration of the pixel units gradually increases, which helps in heat dissipation and further controls the temperature of the display device.

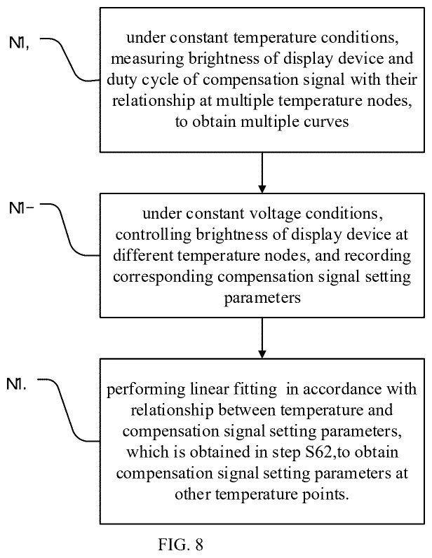

Specifically, the temperature lookup table in step S41 of FIG. 5 can be obtained by an establishing approach for the temperature lookup table shown in FIG. 8:

In step S61: Under constant temperature conditions, the brightness of the display device and the duty cycle of the compensation signal EOA are measured with their relationship at multiple temperature nodes, to obtain multiple curves.

In step S62: Under constant voltage conditions, the brightness of the display device is controlled at different temperature nodes, and the corresponding compensation signal setting parameters are recorded.

In a possible embodiment, at different temperature nodes, the brightness of the display device is made to be the same as the brightness at the reference temperature, and the corresponding compensation signal setting parameters are recorded.

Specifically, taking 30 °C as the reference temperature, at 40 °C and 50 °C, the display device is made to be the same brightness as at 30 °C, and the compensation signal setting parameters (e.g., the duty cycle of the compensation signal EOA) at 40 °C and 50 °C are recorded.

It should be understood that the temperature range, selection of temperature nodes, and reference temperature in the present disclosure can be flexibly adjusted according to actual application needs, for example, within a temperature range of 30 °C to 50 °C, five temperature nodes of 30 °C, 35 °C, 40 °C, 45 °C, and 50 °C, with 30 °C are selected as the reference temperature.

In another possible embodiment, overcompensation can be performed when the temperature is higher than the reference temperature. For example, without overcompensation, at 30 °C, the duty cycle of the compensation signal EOA is 90%, with a brightness of 300 nits, at 40 °C, the duty cycle is 80%, with a brightness of 300 nits, and at 50 °C, the duty cycle is 50%, with a brightness of 300 nits. To perform overcompensation, when the temperature node is higher than the reference temperature, the brightness of the display device appropriately decreases to achieve better cooling effects, and the compensation signal setting parameter is recorded at this time.

As an example, when overcompensation is adopted, at 30 °C, the duty cycle of the compensation signal EOA is 90%, with a brightness of 300 nits, at 40 °C, the brightness is adjusted to 290 nits, with a duty cycle of 75%, and at 50 °C, the brightness is adjusted to 290 nits, with a duty cycle of 45%. That is, by shortening the light-emitting duration of the pixel unit 101, the brightness is sacrificed for better cooling effects.

Further, as the temperature rises, the overcompensation can be performed with an increased rate, i.e., at 30 °C, the brightness is 300 nits, and a duty cycle of the compensation signal EOA is 90%, at 40 °C, the brightness is adjusted to 290 nits, with a duty cycle of 75%, and at 50 °C, the brightness is adjusted to 280 nits, with a duty cycle of 40%. When the temperature of the display device is low, the overcompensation is performed with a small rate (e.g., reducing by 5% at 40 °C), ensuring heat dissipation while having little impact on the brightness of the display device. When the temperature of the display device is high, the overcompensation is performed with a large rate (e.g., reducing by 10% at 50 °C), sacrificing brightness for better cooling effects, improving the overall stability and reliability of the display device.

The driving method with and without overcompensation is similar. In the process of establishing the temperature lookup table, the duty cycle of the compensation signal EOA is adjusted at different temperature nodes, which will not be repeated here.

In step S63, in accordance with the relationship between temperature and compensation signal setting parameters, which is obtained in step S62, linear fitting is performed to obtain compensation signal setting parameters at other temperature points.

As an example, at 30 °C, the brightness of the display device is 300 nits, and a duty cycle of the compensation signal EOA is 90%, at 40 °C, to make the brightness of the display device still 300 nits, the duty cycle is 80%. When the temperature represented by the temperature information is between 30 °C and 40 °C, automatically calculate the duty cycle of the compensation signal EOA at the corresponding temperature through linear fitting, thereby obtaining a table representing the relationship between temperature information and corresponding compensation signal setting parameters.

In summary, the display device and the driving method therefor provided by the present disclosure, when the temperature changes, automatically change the proportion of light-emitting duration of the pixel units 101 by controlling on and off states of the third transistor T3 in the pixel units, maintaining the equivalent brightness of the display device at different temperature nodes consistent with the brightness of the display device at the reference temperature, dynamically balancing temperature and brightness of the display device.

Optionally, as the temperature rises, the proportion of light-emitting duration of the pixel units 101, i.e., the duty cycle of the compensation signal EOA, gradually decreases to achieve the effect of maintaining consistent equivalent brightness. On one hand, the brightness no longer increases with the rise of temperature, ensuring the display device has a good display effect and a long service life. On the other hand, as the temperature rises, the proportion of non-light-emitting duration of the pixel units 101 gradually increases, which helps in heat dissipation and further controls the temperature of the display device.

Optionally, the present disclosure can also perform overcompensation when the temperature represented by the temperature information is higher than the reference temperature, sacrificing brightness for better cooling effects. Further, the degree of overcompensation is positively correlated with the temperature of the display device. When the temperature of the display device is low, the degree of overcompensation is small (e.g., reducing by 5% at 40 °C), ensuring heat dissipation while having little impact on the brightness of the display device. When the temperature of the display device is high, increase the degree of overcompensation (e.g., reducing by 10% at 50 °C), sacrificing brightness for better cooling effects, improving the overall stability and reliability of the display device.

It should be noted that those skilled in the art can understand that the terms “during,” “when,” and “when . . . then” related to circuit operation used herein are not strict terms indicating actions occurring immediately at the start of an action but may have some small but reasonable one or more delays between them and the reaction actions initiated by the start action, such as various transmission delays. The terms “approximately” or “substantially” used herein mean that the element value has a parameter that is expected to be close to the declared value or position. However, as is well known in the art, there are always slight deviations that make it difficult for the value or position to be strictly the declared value. It has been appropriately determined in the art that at least ten percent (10%) (for semiconductor doping concentration, at least twenty percent (20%)) deviation is a reasonable deviation from the accurately described ideal target. When used in conjunction with signal states, the actual voltage value or logic state (e.g., “1” or “0”) of the signal depends on whether positive logic or negative logic is used.

According to the embodiments of the present disclosure as described above, these embodiments do not exhaustively describe all details, nor do they limit the invention to the specific embodiments. It is apparent that many modifications and variations can be made in accordance with the above description. The specification selects and specifically describes these embodiments to better explain the principles and practical applications of the present disclosure, enabling those skilled in the art to better utilize the present disclosure and make modifications in accordance with the present disclosure. The scope of protection of the present disclosure should be defined by the claims and their equivalents.

1. A driving method for a display device, the display device comprising a plurality of pixel units arranged in an array, the driving method comprising:
sensing a current temperature of the display device to obtain temperature information;
obtaining a compensation signal with a selected duty cycle in accordance with the temperature information and a temperature lookup table; and
dynamically adjusting a light-emitting duration of the plurality of pixel units in each frame in accordance with the compensation signal.

2. The driving method according to claim 1, wherein the step of obtaining a compensation signal with a selected duty cycle in accordance with the temperature information and the temperature lookup table comprises:
looking up corresponding a compensation signal setting parameter in the temperature lookup table in accordance with the temperature information; and
generating the compensation signal with the selected duty cycle in accordance with the compensation signal setting parameter.

3. The driving method according to claim 1, wherein the step of establishing the temperature lookup table comprises:
under constant temperature conditions, measuring a brightness of the display device and a duty cycle of the compensation signal to obtain their relationship at a plurality of temperature nodes;
under constant voltage conditions, controlling the brightness of the display device at different temperature nodes and recording corresponding compensation signal setting parameters;
performing linear fitting in accordance with the relationship between brightness and compensation signal setting parameters to obtain compensation signal setting parameters at other temperatures.

4. The driving method according to claim 3, wherein under constant voltage conditions, controlling the brightness of the display device at different temperature nodes and recording corresponding compensation signal setting parameters comprises:
at different temperature nodes, making the brightness of the display device the same as the brightness of the display device at a reference temperature, and recording the corresponding compensation signal setting parameters.

5. The driving method according to claim 3, wherein under constant voltage conditions, controlling the brightness of the display device at different temperature nodes and recording corresponding compensation signal setting parameters comprises:
when the temperature node is higher than the reference temperature, making the brightness of the display device lower than the brightness of the display device at the reference temperature, and recording the corresponding compensation signal setting parameters.

6. The driving method according to claim 5, wherein making the brightness of the display device lower than the brightness of the display device at the reference temperature comprises:
the brightness of the display device decreases in a rate that increases as the temperature node rises.

7. The driving method according to claim 1, wherein when the temperature represented by the temperature information is greater than a preset temperature, the display device is turned off.

8. A display device capable of executing the driving method according to claim 1, the display device comprising:
a pixel array, having a plurality of pixel units at intersecting points of a plurality of scan lines and a plurality of data lines;
a temperature sensing unit configured to sense a temperature of the pixel array to obtain temperature information;
a plurality of compensation lines, each compensation line coupled to at least one pixel unit in the same row; and
a brightness compensation circuit coupled to the temperature sensing unit and the plurality of compensation lines, generating a compensation signal with a selected duty cycle in accordance with the temperature information to control a light-emitting duration of the pixel units.

9. The display device according to claim 8, wherein the pixel unit comprises:
a first transistor, with a control terminal coupled to a scan line, and a first terminal coupled to the data line;
a third transistor, a second transistor, and a light-emitting device sequentially coupled in series between an operating voltage and ground, a control terminal of the third transistor coupled to a compensation line;
a first capacitor, with one end coupled to a control terminal of the second transistor, and the other end coupled to an intermediate node between the second transistor and the third transistor.

10. The display device according to claim 9, further comprising:
a gate driving circuit coupled to the plurality of scan lines, providing a plurality of gate driving signals to turn on or off the plurality of pixel units coupled to the plurality of scan lines;
a source driving circuit coupled to the plurality of data lines, providing gray-scale display voltages to corresponding pixel units when the pixel units are turned on;
a timing control circuit coupled to the gate driving circuit, the source driving circuit, and the brightness compensation circuit to provide corresponding timing signals and control signals.

11. The display device according to claim 8, wherein the pixel array is selected from that of an LCD display, an LED display, an OLED display, an AMOLED display, a Micro LED display, or a Mini LED display.
